(19) United States
(12) Patent Application Publication
(10) Pub. No.: US 2026/0043436 A1
(43) Pub. Date: Feb. 12, 2026

(54) REPLACEABLE BALL JOINT ASSEMBLY

(71) Applicant: Textron Inc., Providence, RI (US)

(72) Inventors: Lajos Mitro, Stowmarket (GB); Robert John Cooper, Ipswich (GB); Adrian Robert Kindred, Ipswich (GB)

(73) Assignee: Textron Inc., Providence, RI (US)

(21) Appl. No.: 18/798,416

(22) Filed: Aug. 8, 2024

(51) Int. Cl. F16C 11/06; A01D 34/64; A01D 34/81; A01D 101/00

(52) U.S. Cl. CPC F16C 11/0685; A01D 34/64; A01D 34/81; A01D 2101/00

(57) ABSTRACT

A turf mower includes a chassis, a plurality of tractive elements, and a mower assembly. The mower assembly includes a mower deck having a first interface, an arm having a second interface pivotably coupled to the chassis and a third interface, and a ball joint assembly coupled to the first interface and the third interface. The ball joint assembly includes a plate removably coupled to the third interface of the arm. The plate defines a first aperture. The ball joint assembly includes a ball joint at least partially received by the first aperture. The ball joint defines a second aperture. The ball joint assembly includes a fastener extending from the first interface through the second aperture to couple the ball joint, and thereby, coupling the plate and the arm to the mower deck.

### BACKGROUND

Mowers are used to maintain vegetation (e.g., grass, clover, weeds, etc.) at a desired height. While mowing, mower decks are lifted and lowered to follow the undulations of the lawn. Due to the motion of the mower deck, the mower deck may be attached to the chassis by a movable joint, or ball joint. Due to the relative motion between the ball joint and the ball joint housing, the ball joint wears over time. In a conventional turf mower, to replace the worn joint, a user must remove several non-worn components (e.g., a carrier plate, wing arms, bushes, bracing plates, etc.) to access the ball joint. This process wastes time and can be cost and/or labor intensive.

### SUMMARY

One embodiment relates to a turf mower. The turf mower includes a chassis, a plurality of tractive elements, and a mower assembly. The mower assembly includes a mower deck having a first interface, an arm having a second interface pivotably coupled to the chassis and a third interface, and a ball joint assembly coupled to the first interface and the third interface. The ball joint assembly includes a plate removably coupled to the third interface of the arm. The plate defines a first aperture. The ball joint assembly also includes a ball joint at least partially received by the first aperture. The ball joint defines a second aperture. The ball joint assembly also includes a fastener extending from the first interface through the second aperture to couple the ball joint and thereby, the plate and the arm to the mower deck.

Another embodiment relates to a ball joint assembly for a turf mower. The ball joint assembly includes a plate defining a first aperture, a ball joint at least partially received by the first aperture, and a fastener. The ball joint defines a second aperture. The fastener is configured to extend through the second aperture of the ball joint to facilitate releasably coupling the ball joint to a mower deck of the turf mower.

Still another embodiment relates to a ball joint assembly for a mower deck. The ball joint assembly includes a plate, a ball joint, a first fastener, and a plurality of second fasteners. The plate defines a first aperture. The plate including a plurality of protrusions spaced around a periphery thereof. The plurality of protrusions define a plurality of second apertures. The ball joint is at least partially received by the first aperture. The ball joint defines a third aperture.

The first fastener is configured to extend through the third aperture of the ball joint to facilitate releasably coupling the ball joint to the mower deck. The plurality of second fasteners are configured to extend though the plurality of second apertures to couple the plate to a wing arm of the mower deck.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

FIG. 1 is a perspective view of a vehicle, according to an embodiment.

FIG. 2 is a schematic block diagram of the vehicle of FIG. 1, according to an exemplary embodiment.

FIG. 3 is a perspective view of the vehicle of FIG. 1 including a mower deck assembly, the mower deck assembly including an arm assembly and a ball joint assembly, according to an exemplary embodiment.

FIG. 4 is a top view of the mower deck assembly of FIG. 3, according to an exemplary embodiment.

FIG. 5 is another perspective view of the mower deck assembly of FIG. 3, according to an exemplary embodiment.

FIG. 6 is a top view of the arm assembly of FIG. 3, according to an exemplary embodiment.

FIG. 7 is another top view of the arm assembly of FIG. 3, according to an exemplary embodiment.

FIG. 8 is a top view of the ball joint assembly of FIG. 3, according to an exemplary embodiment.

FIG. 9 is a perspective view of the ball joint assembly of FIG. 8, according to an exemplary embodiment.

FIG. 10 is a side view of the ball joint assembly of FIG. 8, according to an exemplary embodiment.

FIG. 11 is another perspective view of the ball joint assembly of FIG. 8, according to an exemplary embodiment.

FIG. 12 is another perspective view of the ball joint assembly of FIG. 8, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

### Overall Vehicle

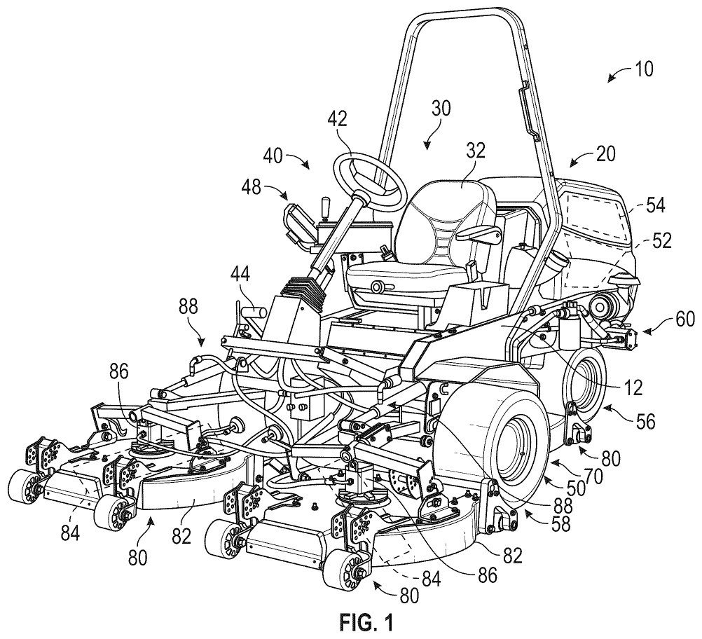

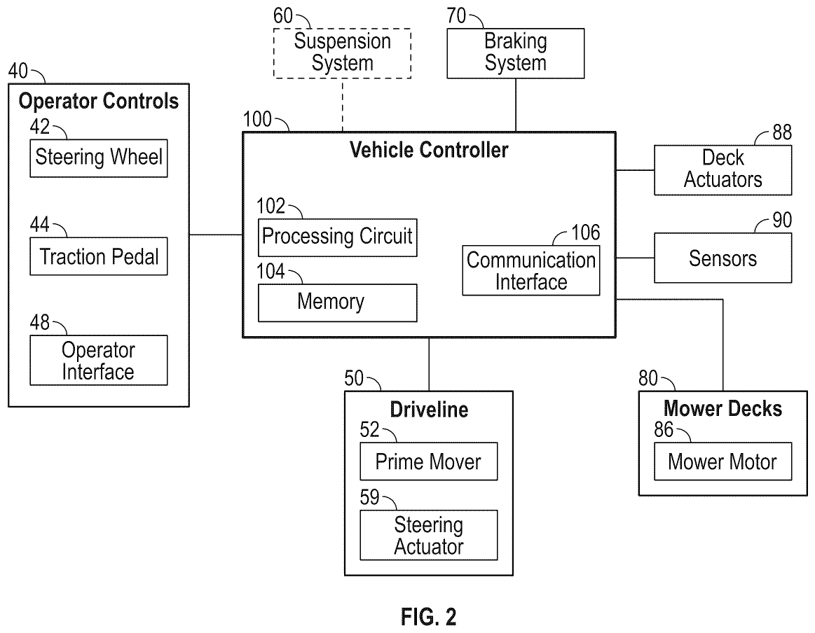

As shown in FIGS. 1 and 2, a machine or vehicle, shown as vehicle 10, includes a chassis, shown as frame 12; a body assembly, shown as body 20, coupled to the frame 12 and having an occupant portion or section, shown as occupant seating area 30; operator input and output devices, shown as operator controls 40, that are disposed within the occupant seating area 30; a drivetrain, shown as driveline 50, coupled to the frame 12 and at least partially disposed under the body 20; a vehicle suspension system, shown as suspension system 60, coupled to the frame 12 and one or more components of the driveline 50; a vehicle braking system, shown as braking system 70, coupled to one or more components of the driveline 50 to facilitate selectively braking the one or more components of the driveline 50; a series of implements, mower assemblies, or cutting units, shown as mower decks 80; one or more sensors, shown as sensors 90; and a vehicle control system, shown as vehicle controller 100, coupled to the operator controls 40, the driveline 50, the suspension system 60, the braking system 70, the mower decks 80, and the sensors 90. In other embodiments, the vehicle 10 includes more or fewer components.

According to an exemplary embodiment, the vehicle 10 is an off-road machine or vehicle. As shown in FIG. 1, the vehicle 10 is configured as a mower (e.g., a lawnmower, a turf mower, a push mower, a ride-on mower, a stand-on mower, or another type of mower). In other embodiments, the off-road machine or vehicle is a lightweight or recreational machine or vehicle such as a golf cart, golf cars, an all-terrain vehicle (“ATV”), a utility task vehicle (“UTV”), and/or another type of lightweight or recreational machine or vehicle. In some embodiments, the off-road machine or vehicle is a chore product such as aerator, turf sprayer, bunker rake, and/or another type of chore product (e.g., that may be used on a golf course).

According to the exemplary embodiments shown in FIG. 1, the occupant seating area 30 includes a single seat, shown as driver seat 32. In some embodiments, the occupant seating area 30 includes additional seats (e.g., a passenger seat, an additional row of seats, etc.). According to the exemplary embodiments shown in FIG. 1, the driver seat 32 is laterally centered on the body 20 and facing forward. In some embodiments, the driver seat 32 is facing rearward or otherwise positioned. In some embodiments, the occupant seating area 30 is omitted (e.g., the vehicle 10 is configured as a push mower). A portion of the frame 12 defines a platform, deck, or standing area, shown as operator platform 34. The operator platform 34 may extend forward of the driver seat 32 such that the occupant can rest their feet on the operator platform 34 while seated in the driver seat 32. The operator platform 34 may support the occupant as the occupant enters or exits the driver seat 32.

According to an exemplary embodiment, the operator controls 40 are configured to provide an operator with the ability to control one or more functions of and/or provide commands to the vehicle 10 and the components thereof (e.g., turn on, turn off, drive, turn, brake, engage various operating modes, raise/lower a mower deck 80, etc.). As shown in FIGS. 1 and 2, the operator controls 40 include a steering interface (e.g., a steering wheel, joystick(s), etc.), shown steering wheel 42, an accelerator interface and/or braking interface (e.g., a pedal, a throttle, etc.), shown as traction pedal 44, and one or more additional interfaces, shown as operator interface 48. The steering wheel 42 may be used by an operator to indicate a desired steering direction of the vehicle 10. The traction pedal 44 may be used to control the speed and direction of travel of the vehicle 10. By way of example, pressing the traction pedal 44 in a first direction may cause the driveline 50 to move the vehicle 10 forward, and pressing the traction pedal 44 in an opposing section direction may cause the driveline 50 to move the vehicle 10 rearward. Returning the traction pedal 44 to a middle or neutral position may cause the braking system 70 and/or the driveline 50 to slow or stop the vehicle 10 or to hold the vehicle 10 in place. Alternatively, the operator interface 48 may include a pair of handles that act as a steering interface and control the driveline 50 in a zero-turn configuration (e.g., a left joystick to control the left side of the driveline 50 and a right joystick to control a right side of the driveline 50). The operator interface 48 may be used to control operation of the mower decks 80 (e.g., changing a cutting speed of a mower deck 80, changing a cutting height of a mower deck 80, etc.). The operator interface 48 may include one or more displays and one or more input devices. The one or more displays may be or include a touchscreen, an LCD display, a LED display, a speedometer, gauges, warning lights, etc. The one or more input device may be or include buttons, switches, knobs, levers, dials, etc.

According to an exemplary embodiment, the driveline 50 is configured to propel the vehicle 10. As shown in FIG. 1, and 2, the driveline 50 includes a primary driver, shown as prime mover 52, an energy storage device, shown as energy storage 54, a first tractive assembly (e.g., axles, wheels, tracks, differentials, etc.), shown as rear tractive assembly 56, and a second tractive assembly (e.g., axles, wheels, tracks, differentials, etc.), shown as front tractive assembly 58. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline whereby the prime mover 52 is one or more electric motors and the energy storage 54 is a battery system. In some embodiments, the driveline 50 is a fuel cell electric driveline whereby the prime mover 52 is one or more electric motors and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system. According to the exemplary embodiments shown in FIG. 1, the rear tractive assembly 56 includes rear tractive elements and the front tractive assembly 58 includes front tractive elements that are configured as wheels. In some embodiments, the rear tractive elements and/or the front tractive elements are configured as tracks. In some embodiments, the driveline 50 is omitted, and the vehicle 10 is propelled by an operator (e.g., the vehicle 10 is configured as a push mower).

According to an exemplary embodiment, the prime mover 52 is configured to provide power to drive the rear tractive assembly 56 and/or the front tractive assembly 58 (e.g., to provide front-wheel drive, rear-wheel drive, four-wheel drive, and/or all-wheel drive operations). In some embodiments, the driveline 50 includes a transmission device (e.g., a gearbox, a continuous variable transmission (“CVT”), etc.) positioned between (a) the prime mover 52 and (b) the rear tractive assembly 56 and/or the front tractive assembly 58. The rear tractive assembly 56 and/or the front tractive assembly 58 may include a drive shaft, a differential, and/or an axle. In some embodiments, the rear tractive assembly 56 and/or the front tractive assembly 58 include two axles or a tandem axle arrangement. In some embodiments, the rear tractive assembly 56 and/or the front tractive assembly 58 are steerable (e.g., based on an input from the steering wheel 42 and using a steering actuator 59 that controls the orientation of one or more wheels). In some embodiments, both the rear tractive assembly 56 and the front tractive assembly 58 are fixed and not steerable (e.g., employ skid steer operations). By way of example, the driveline 50 may include a hydrostatic transmission that permits independent driving of the left and right sides of the driveline 50.

In some embodiments, the driveline 50 includes a plurality of prime movers 52. By way of example, the driveline 50 may include a first prime mover 52 that drives the rear tractive assembly 56 and a second prime mover 52 that drives the front tractive assembly 58. By way of another example, the driveline 50 may include a first prime mover 52 that drives a first one of the front tractive elements, a second prime mover 52 that drives a second one of the front tractive elements, a third prime mover 52 that drives a first one of the rear tractive elements, and/or a fourth prime mover 52 that drives a second one of the rear tractive elements. By way of still another example, the driveline 50 may include a first prime mover 52 that drives the front tractive assembly 58, a second prime mover 52 that drives a first one of the rear tractive elements, and a third prime mover 52 that drives a second one of the rear tractive elements. By way of yet another example, the driveline 50 may include a first prime mover 52 that drives the rear tractive assembly 56, a second prime mover 52 that drives a first one of the front tractive elements, and a third prime mover 52 that drives a second one of the front tractive elements.

According to an exemplary embodiment, the suspension system 60 includes one or more suspension components (e.g., shocks, dampers, springs, etc.) positioned between the frame 12 and one or more components (e.g., tractive elements, axles, etc.) of the rear tractive assembly 56 and/or the front tractive assembly 58. In some embodiments, the vehicle 10 does not include the suspension system 60.

According to an exemplary embodiment, the braking system 70 includes one or more braking components (e.g., disc brakes, drum brakes, in-board brakes, axle brakes, etc.) positioned to facilitate selectively braking one or more components of the driveline 50. In some embodiments, the one or more braking components include (i) one or more front braking components positioned to facilitate braking one or more components of the front tractive assembly 58 (e.g., the front axle, the front tractive elements, etc.) and (ii) one or more rear braking components positioned to facilitate braking one or more components of the rear tractive assembly 56 (e.g., the rear axle, the rear tractive elements, etc.). In some embodiments, the one or more braking components include only the one or more front braking components. In some embodiments, the one or more braking components include only the one or more rear braking components. In some embodiments, the one or more front braking components include two front braking components, one positioned to facilitate braking each of the front tractive elements. In some embodiments, the one or more rear braking components include two rear braking components, one positioned to facilitate braking each of the rear tractive elements. In some embodiments, the driveline 50 is a hydrostatic transmission that performs braking by using hydraulic motors to oppose movement of the tractive elements.

Referring to FIG. 1, the vehicle 10 includes a series of mower decks 80 (e.g., cutting units). Each mower deck 80 includes a deck, housing, or enclosure, shown as housing 82, and a cutting element 84 (e.g., a blade, a flail, a reel, etc.) movably coupled to the housing 82. Specifically, the vehicle of FIG. 1 illustrates a vehicle 10 in which the mower decks 80 each include a cutting element 84 configured as a blade that rotates about a substantially vertical axis.

Referring to FIG. 1, the housing 82 may open downward to expose the cutting element 84 to vegetation below the housing 82. A motor or actuator (e.g., an electric motor, a hydraulic motor, etc.), shown as mower motor 86, is coupled to the housing 82 and drives movement (e.g., rotation, oscillation, etc.) of the cutting element 84. While driven by the mower motor 86, the cutting element 84 crushes, mulches, removes, or otherwise trims vegetation beneath the housing 82. Alternatively, the cutting element 84 may be driven by the prime mover 52 (e.g., through a power take off).

The vehicle 10 includes a series of linear actuators or height adjustment actuators, shown as deck actuators 88, each coupled to the frame 12 and to one or more of the mower decks 80. The deck actuators 88 permit control over a height of the corresponding mower deck 80 relative to the frame 12. The deck actuators 88 may set a cutting height of the mower deck 80. The cutting height represents a final height of vegetation that is trimmed by the mower deck 80. The deck actuators 88 may move the mower deck 80 to a travel position above the cutting height, in which the mower deck 80 is moved out of engagement with the vegetation and the ground surface. The travel position may be used when the vehicle 10 is traveling between job sites and/or the user does not wish to be trimming vegetation.

The sensors 90 may include various sensors positioned about the vehicle 10 to acquire vehicle information or vehicle data regarding operation of the vehicle 10, or the location thereof. The sensors 90 may include various sensors positioned about the vehicle 10 to acquire environment data regarding the environment surrounding the vehicle 10. By way of example, the sensors 90 may include an accelerometer, a gyroscope, a compass, a position sensor (e.g., a GPS sensor, an RTK sensor, etc.), an inertial measurement unit (“IMU”), suspension sensor(s), wheel sensors, an audio sensor or microphone, a camera, an optical sensor, a proximity detection sensor, linear potentiometers, and/or other sensors to facilitate acquiring vehicle information, vehicle data, or environment data regarding operation of the vehicle 10, the location thereof, and/or the surrounding environment. According to an exemplary embodiment, one or more of the sensors 90 are configured to facilitate detecting and obtaining vehicle telemetry data including position of the vehicle 10, whether the vehicle 10 is moving, travel direction of the vehicle 10, slope of the vehicle 10, speed of the vehicle 10, vibrations experienced by the vehicle 10, sounds proximate the vehicle 10, suspension travel of components of the suspension system 60, and/or other vehicle telemetry data.

As shown in FIG. 2, the vehicle controller 100 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. According to the exemplary embodiment shown in FIG. 2, the vehicle controller 100 includes a processing circuit 102, a memory 104, and a communication interface 106. The processing circuit 102 may include an ASIC, one or more FPGAs, a DSP, circuits containing one or more processing components, circuitry for supporting a microprocessor, a group of processing components, or other suitable electronic processing components. In some embodiments, the processing circuit 102 is configured to execute computer code stored in the memory 104 to facilitate the activities described herein. The memory 104 may be any volatile or non-volatile or non-transitory computer-readable storage medium capable of storing data or computer code relating to the activities described herein. According to an exemplary embodiment, the memory 104 includes computer code modules (e.g., executable code, object code, source code, script code, machine code, etc.) configured for execution by the processing circuit 102. In some embodiments, the vehicle controller 100 may represent a collection of processing devices. In such cases, the processing circuit 102 represents the collective processors of the devices, and the memory 104 represents the collective storage devices of the devices.

In one embodiment, the vehicle controller 100 is configured to selectively engage, selectively disengage, control, or otherwise communicate with components of the vehicle 10 (e.g., via the communication interface 106, a controller area network (“CAN”) bus, etc.). According to an exemplary embodiment, the vehicle controller 100 is coupled to (e.g., communicably coupled to) components of the operator controls 40 (e.g., the steering wheel 42, the traction pedal 44, the brake 46, the operator interface 48, etc.), components of the driveline 50 (e.g., the prime mover 52), components of the braking system 70, the mower decks 80, the deck actuators 88, and the sensors 90. By way of example, the vehicle controller 100 may send and receive signals (e.g., control signals, location signals, etc.) with the components of the operator controls 40, the components of the driveline 50, the components of the braking system 70, the sensors 90, and/or remote systems or devices (via the communication interface 106 as described in greater detail herein).

The communication interface 106 facilitate communications (e.g., wired or wireless communications) between the vehicle 10 and other devices (e.g., other vehicles 10, a server, etc.). By way of example, the communication interface 106 may be configured to employ one or more types of wireless communications protocols including Bluetooth, Wi-Fi, radio, cellular, and/or other suitable wireless communications protocols.

### Ball Joint Assembly

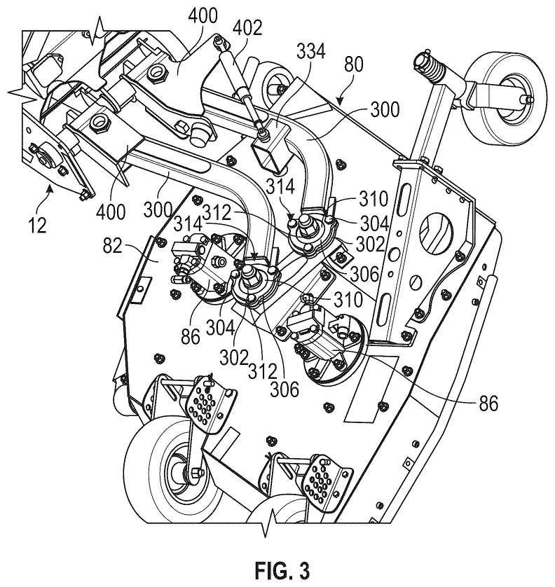

As shown in FIG. 3-7, a mower assembly of the vehicle 10 includes the mower deck 80, a plurality of first arms (e.g., wing arms, housing arms, housing connection members, etc.), shown as wing arms 300, a plurality of first plates (e.g., receiving plates, etc.), shown as wing arm plates 302, a plurality of joints (e.g., chassis connection piece, etc.), shown as articulating joints 400, a second arm (e.g., connection member, a support, etc.), shown as support arm 402, a plurality of fasteners, shown as peripheral fasteners 304, and a plurality of ball joint assemblies, shown as ball joint assemblies 314. The wing arms 300 are configured to facilitate raising and lowering the mower deck 80. Each of the wing arms 300 includes a first end, shown as wing arm first end 316, and an opposing second end, shown as wing arm second end 318. The wing arm plates 302 are coupled to the wing arm second ends 318 of the wing arms 300. In some embodiments, the wing arm plates 302 are welded to the wing arm second ends 318 of the wing arms 300. In some embodiments, the wing arm plates 302 are integrally formed with the wing arm second ends 318 of the wing arms 300. In some embodiments, the wing arm plates 302 are detachably coupled to the wing arm second ends 318 of the wing arms 300.

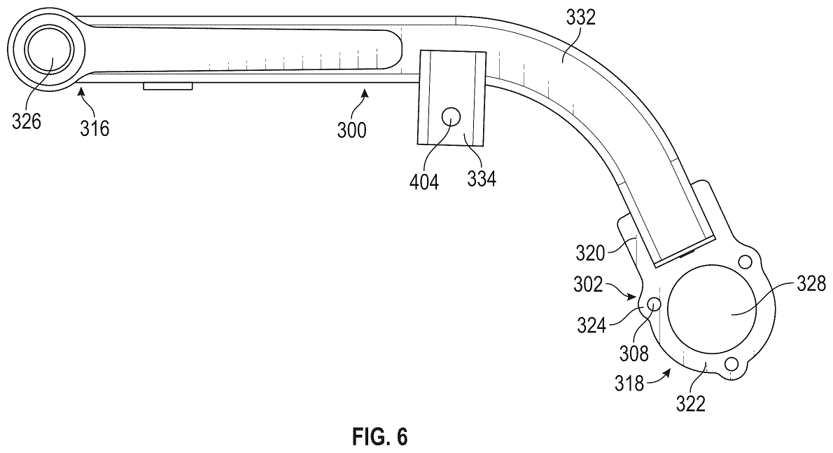

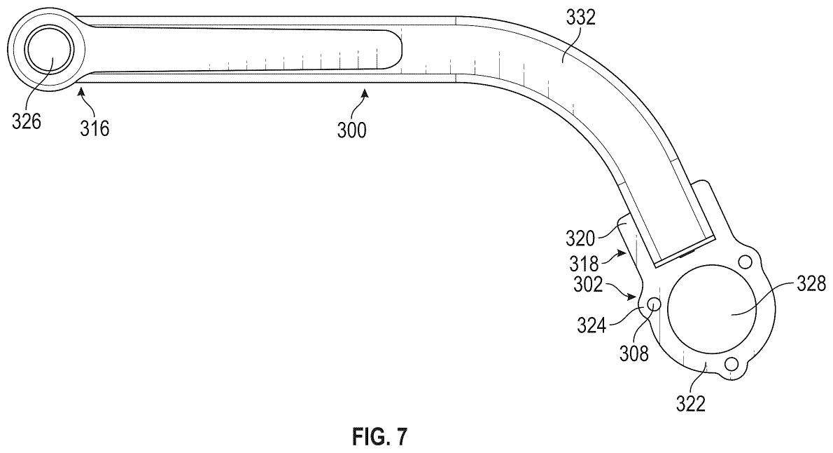

As shown in FIGS. 6 and 7, the wing arm first ends 316 of the wing arms 300 define a connector interface, shown as first end connectors 326. As shown in FIG. 3, the articulating joints 400 are coupled to the frame 12 and the first end connectors 326 of the wing arm first ends 316 of the wing arms 300 are coupled to the articulating joints 400. As shown in FIGS. 6 and 7, each of the wing arms 300 includes a bend, shown as elbow 332, positioned along a length thereof between the wing arm first end 316 and the wing arm second end 318 such that the wing arms 300 have an at least partially curved shape. As shown in FIGS. 3 and 6, one of the wing arms 300 includes a support interface, shown as support protrusion 334, extending therefrom proximate the elbow 332. As shown in FIG. 6, the support protrusion 334 defines an aperture, shown as support aperture 404. As shown in FIG. 3, the support aperture 404 is configured to provide a coupling location for the support arm 402 such that the support arm 402 extends between one of the articulating joints 400 and the support protrusion 334.

As shown in FIGS. 6 and 7, the wing arm plate 302 includes a first portion, shown as base 320, and a second portion, shown as ball joint interface 322. The base 320 is coupled to the wing arm second end 318 of the wing arm 300. The ball joint interface 322 extends from the base 320 away from the wing arm second end 318 of the wing arm 300. As shown in FIG. 3-5, the ball joint interfaces 322 of the wing arms 300 are configured to at least partially receive and engage with the ball joint assembly 314, which is described in greater detail herein.

As shown in FIGS. 6 and 7, the ball joint interface 322 has a ring shaped structure that (a) defines a first aperture, shown as wing arm plate aperture 328, and (b) includes a plurality of first protrusions (e.g., projections, etc.), shown as protrusions 324, spaced around the periphery of the ring shaped structure. Each of the protrusions 324 defines an aperture, shown as peripheral apertures 308. According to the exemplary embodiment shown in FIGS. 6 and 7, the ball joint interface 322 includes three equally spaced protrusions 324 extending from the periphery of the ring shaped structure. In some embodiments, the ball joint interface 322 includes more than three protrusions 324. In some embodiments, the ball joint interface 322 has another shape (e.g., a square shape, a rectangular shape, a hexagon shape, an octagon shape, an oval shape, etc.).

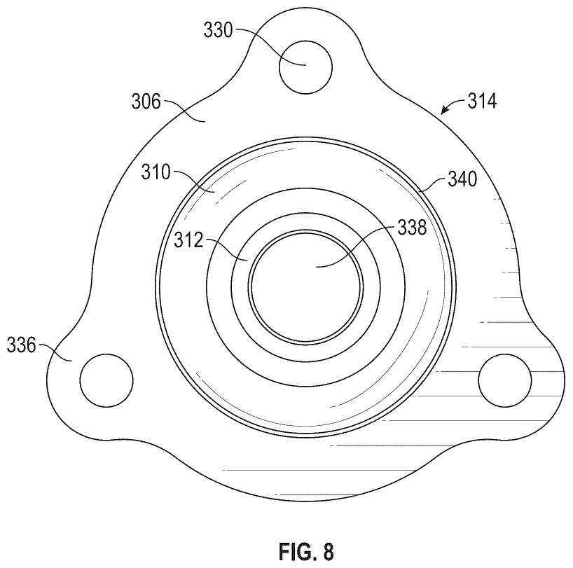

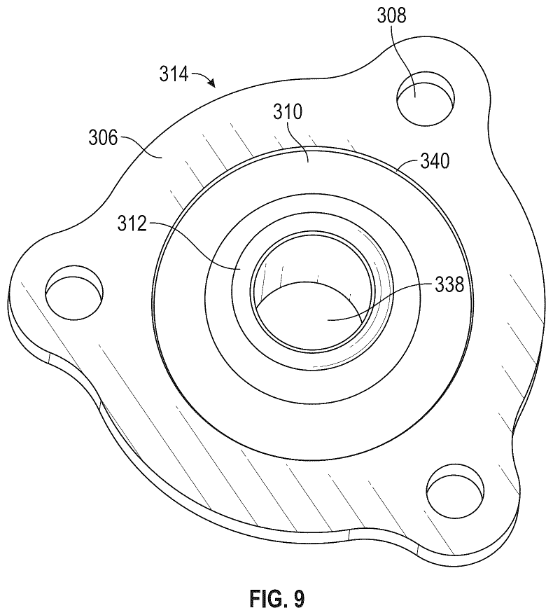

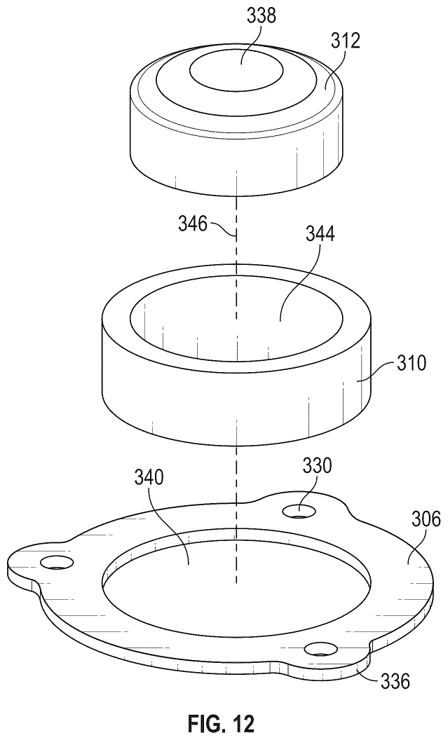

As shown in FIG. 3-5 and 8-12, each ball joint assembly 314 includes a second plate (e.g., carrier plate, etc.), shown as ball joint plate 306, a housing, shown as ball joint housing 310, and a bearing, shown as ball joint 312. As shown in FIG. 8-12, the ball joint plate 306 defines an aperture, shown as plate aperture 340. As shown in FIG. 8-10 and 12, the ball joint plate 306 and the ball joint housing 310 are separate components and the plate aperture 340 is configured to at least partially receive the ball joint housing 310. The ball joint housing 310 may be fixedly coupled (e.g., secured, welded.) to the ball joint plate 306.

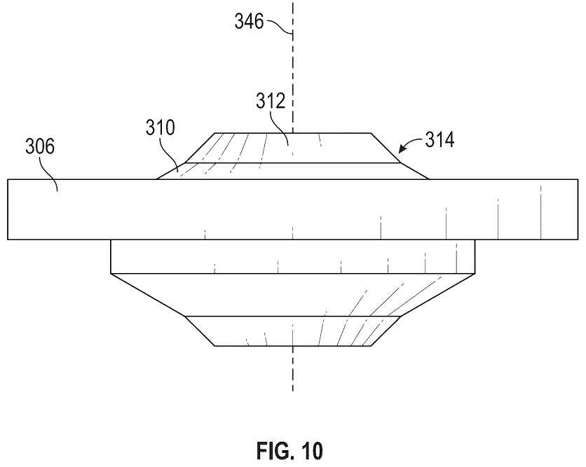

As shown in FIG. 8-12, the ball joint housing 310 defines an aperture, shown as ball joint housing aperture 344, configured to at least partially receive the ball joint 312. The ball joint 312 may be press fit into the ball joint housing 310 to couple the ball joint 312 to the ball joint housing 310. As shown in FIGS. 8, 9, 11, and 12, the ball joint defines an aperture, shown as ball joint aperture 338. As shown in FIG. 10-12, the plate aperture 340 of the ball joint plate 306, the ball joint housing aperture 344 of the ball joint housing 310, and the ball joint aperture 338 of the ball joint 312 are parallel and coincident with an axis, shown as center axis 346, of the ball joint assembly 314 when the ball joint plate 306, the ball joint housing 310, and the ball joint 312 are assembled.

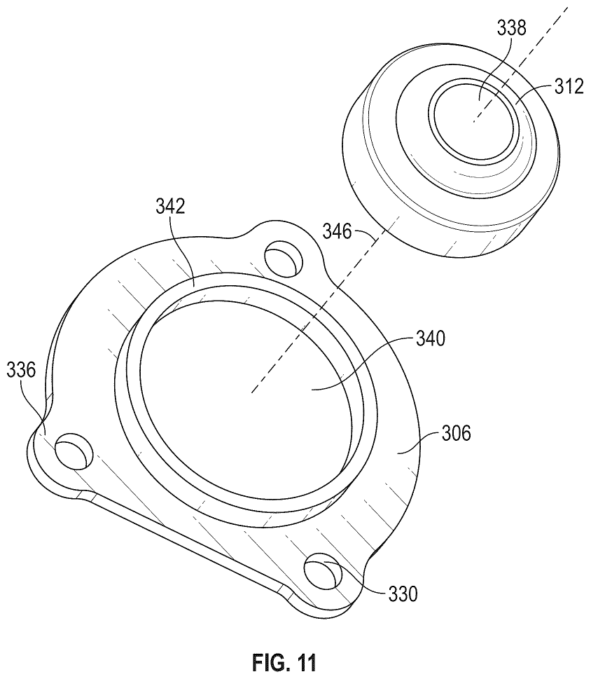

As shown in FIG. 11, the ball joint assembly 314 does not include the ball joint housing 310. Rather, the ball joint plate 306 includes a flange, shown as ball joint plate lip 342, integrally formed with the ball joint plate 306 and extending around the periphery of the plate aperture 340. More specially, the ball joint plate lip 342 extends outward from the ball joint plate 306 perpendicular or substantially perpendicular thereto. The ball joint plate lip 342 is configured to provide a mounting location for connection with the ball joint 312. The ball joint 312 is configured to be inserted into the plate aperture 340 and be coupled to the ball joint plate 306 along the ball joint plate lip 342. In some embodiments, the ball joint housing 310 may be coupled between the ball joint plate lip 342 and the ball joint 312.

As shown in FIG. 8-12, the ball joint plate 306 has a ring shaped structure that (a) defines the plate aperture 340 and (b) includes a plurality of second protrusions (e.g., projections, etc.), shown as protrusions 336, spaced around the periphery of the ring shaped structure. Each of the protrusions 336 defines an aperture, shown as peripheral apertures 330. According to the exemplary embodiment shown in FIG. 8-12, the ball joint plate 306 includes three equally spaced protrusions 336 extending from the periphery of the ring shaped structure. In some embodiments, the ball joint plate 306 includes more than three protrusions 336 (e.g., to correspond with the number of protrusions 324). In some embodiments, the ball joint plate 306 has another shape (e.g., a square shape, a rectangular shape, a hexagon shape, an octagon shape, an oval shape, etc.; to correspond with the shape of the ball joint interface 322, etc.).

As shown in FIG. 3-5, the ball joint assemblies 314 are configured to engage with the ball joint interfaces 322 of the wing arm plates 302 of the wing arms 300 such that (a) the protrusions 336 of the ball joint plates 306 align with the protrusions 324 of the ball joint interfaces 322, (b) the peripheral apertures 330 of the ball joint plates 306 align with the peripheral apertures 308 of the ball joint interfaces 322, and (c) the ball joints 312 align with and are at least partially received by the wing arm plate apertures 328 of the ball joint interfaces 322. When the ball joint assemblies 314 and the ball joint interfaces 322 are in alignment, the peripheral fasteners 304 can be inserted through the peripheral apertures 330 of the ball joint plates 306 and the peripheral apertures 308 of the ball joint interfaces 322 to releasably couple the ball joint assemblies 314 to the wing arms 300.

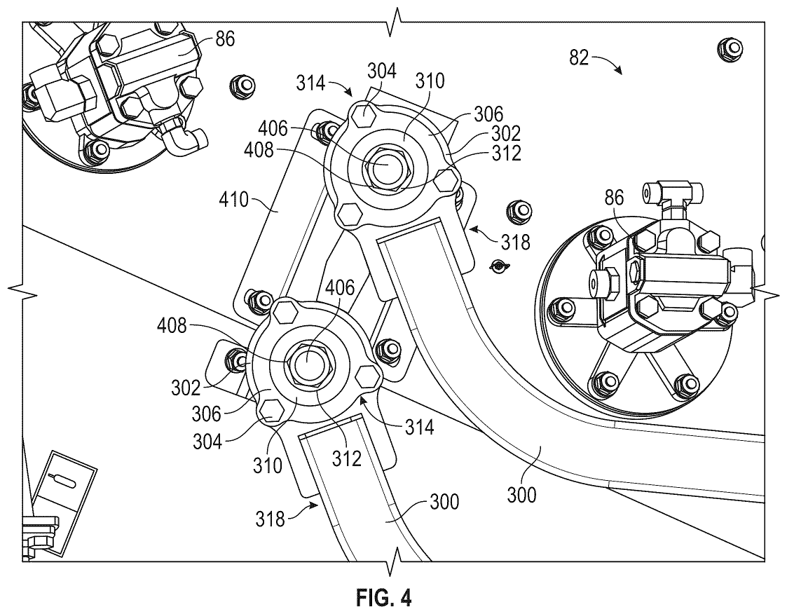

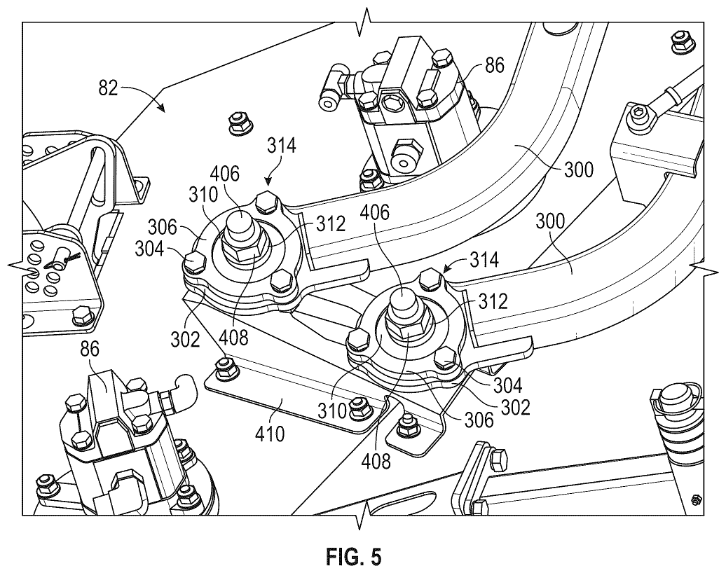

As shown in FIG. 3-5, the wing arm plates 302 at the wing arm second ends 318 of the wing arms 300 are coupled to an interface (e.g., a brace, a support, a protrusion, a flange, etc.), shown as bracket 410, positioned along a top surface of the mower deck 80 via the ball joint assemblies 314, thereby coupling the mower deck 80 to the wings arms 300 and, thereby, the frame 12. In some embodiments, the bracket 410 is omitted and the wing arm second ends 318 are coupled directly to the mower deck 80. As shown in FIGS. 4 and 5, the ball joint assemblies 314 includes mower deck couplings including a rod, shown as ball joint post 406, and a fastener (e.g., a nut), shown as post retainer 408. Each of the ball joint posts 406 extends through an underside of the bracket 410 and through a respective one of the ball joint apertures 338. The free ends of the ball joint posts 406 engage with and receive the post retainers 408 to the ball joint assemblies 314 and, therefore, the wing arm second ends 318 of the wing arms 300 to the bracket 410 and, therefore the mower deck 80. According to an exemplary embodiment, the ball joint assemblies 314 are configured to permit the mower deck 80 to pivot relative to wing arms 300 (e.g., as the mower deck 80 undulates over vegetation).

The removable ball joint assembly 314 is configured to provide several advantages to a user (e.g., a landscaper, a homeowner, etc.) when the ball joint 312 wears. To replace a worn ball joint assembly 314, or component thereof, a user decouples the ball joint assembly 314 from the mower deck 80 and the wing arm 300, replaces the ball joint 312, and couples a new or repaired ball joint assembly 314 to the mower deck 80 and the wing arm 300. This process contrasts with conventional ball joint replacement processes, where a user removes and replaces the entire wing arm 300 to replace the ball joint 312. In the conventional process, the user also may need to remove non-worn components such as brackets to allow for the wing arm 300 to be removed, leading to a labor and time intensive replacement process. The present ball joint assembly 314 is cheaper, easier to install, and less time intensive to replace than replacing the entire wing arm 300 as in conventional turf mowers.

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof (e.g., the body 20, the operator controls 40, the driveline 50, the suspension system 60, the braking system 70, the vehicle controller 100, etc.) as shown in the various exemplary embodiments is illustrative only. Additionally, any element disclosed in one embodiment may be incorporated or utilized with any other embodiment disclosed herein.

1. A turf mower comprising:
a chassis;
a plurality of tractive elements; and
a mower assembly including:
a mower deck having a first interface;
an arm having a second interface pivotably coupled to the chassis and a third interface; and
a ball joint assembly coupled to the first interface and the third interface, the ball joint assembly including:
a plate removably coupled to the third interface of the arm, the plate defining a first aperture;
a ball joint at least partially received by the first aperture, the ball joint defining a second aperture; and
a fastener extending from the first interface through the second aperture to couple the ball joint and, thereby, the plate and the arm to the mower deck.

2. The turf mower of claim 1, wherein the plate defines a plurality of third apertures spaced around a periphery thereof.

3. The turf mower of claim 2, wherein the plate defines a first plurality of protrusions spaced around the periphery thereof, each of the first plurality of protrusions defining one of the plurality of third apertures.

4. The turf mower of claim 2, wherein the third interface of the arm defines a plurality of fourth apertures spaced around a periphery thereof, wherein the plurality of fourth apertures are positioned to align with the plurality of third apertures, wherein the fastener is a first fastener, and wherein the ball joint assembly includes a plurality of second fasteners extending though the plurality of third apertures and the plurality of fourth apertures.

5. The turf mower of claim 1, wherein the fastener includes a threaded post and a nut.

6. The turf mower of claim 1, wherein the ball joint assembly includes a housing at least partially received by the first aperture, and the ball joint at least partially received by the housing.

7. The turf mower of claim 1, wherein the plate includes a lip extending around the first aperture and outward therefrom, and wherein the ball joint is configured to engage with the lip.

8. The turf mower of claim 1, wherein the arm has a first end and a second end, and wherein the arm includes a support interface extending therefrom between the first end and the second end, further comprising a support arm extending from the chassis to the support interface.

9. The turf mower of claim 8, wherein the arm has an elbow positioned between the first end and the second end of the arm, and wherein the support interface is positioned proximate the elbow.

10. A ball joint assembly for a turf mower, the ball joint assembly comprising:
a plate defining a first aperture;
a ball joint at least partially received by the first aperture, the ball joint defining a second aperture; and
a fastener configured to extend through the second aperture of the ball joint to facilitate releasably coupling the ball joint to a mower deck of the turf mower.

11. The ball joint assembly of claim 10, wherein the plate defines a plurality of third apertures spaced around a periphery thereof.

12. The ball joint assembly of claim 11, wherein the plate defines a first plurality of protrusions spaced around the periphery thereof, each of the first plurality of protrusions defining one of the plurality of third apertures.

13. The ball joint assembly of claim 11, wherein the fastener is a first fastener, and wherein the ball joint assembly includes a plurality of second fasteners configured to extend though the plurality of third apertures to couple the plate to a wing arm of the turf mower.

14. The ball joint assembly of claim 10, wherein the fastener includes a threaded post and a nut.

15. The ball joint assembly of claim 10, further comprising a housing at least partially received by the first aperture, and the ball joint at least partially received by the housing.

16. The ball joint assembly of claim 10, wherein the plate includes a lip extending around the first aperture and outward therefrom, and wherein the ball joint is configured to engage with the lip.

17. A ball joint assembly for a mower deck, the ball joint assembly comprising:
a plate defining a first aperture, the plate including a plurality of protrusions spaced around a periphery thereof, the plurality of protrusions defining a plurality of second apertures;
a ball joint at least partially received by the first aperture, the ball joint defining a third aperture;
a first fastener configured to extend through the third aperture of the ball joint to facilitate releasably coupling the ball joint to the mower deck; and
a plurality of second fasteners configured to extend though the plurality of second apertures to couple the plate to a wing arm of the mower deck.

18. The ball joint assembly of claim 17, wherein the first fastener includes a threaded post and a nut.

19. The ball joint assembly of claim 17, further comprising a housing at least partially received by the first aperture, and the ball joint at least partially received by the housing.

20. The ball joint assembly of claim 17, wherein the plate includes a lip extending around the first aperture and outward therefrom, and wherein the ball joint is configured to engage with the lip.
